(19) United States
(12) Patent Application Publication
(10) Pub. No.: US 2026/0215447 A1
(43) Pub. Date: Jul. 30, 2026

(54) PRESERVATIVE AND ANTI-FUNGAL PACKAGING DEVICE

(71) Applicant: TESSARA (PTY) LTD, Cape Town (ZA)

(72) Inventors: Filicity VRIES, Cape Town (ZA); Chanel DANIEL-SWARTLAND, Cape Town (ZA); Renier KEMP, Cape Town (ZA); Elton WILLIAMS, Cape Town (ZA)

(21) Appl. No.: 19/146,464

(22) PCT Filed: Dec. 19, 2023
(86) PCT No.: PCT/IB2023/062905

§ 371 Date: Jul. 8, 2025

(30) Foreign Application Priority Data
Jan. 9, 2023 (ZA) 2023/00329

(51) Int. Cl. A23B 7/152; A01N 59/02; A01P 3/00; B32B 3/26; B32B 7/12; B32B 27/08; B32B 27/32; B32B 27/36; B65D 65/40; B65D 81/28; B65D 85/34

(52) U.S. Cl. CPC A23B 7/152; A01N 59/02; A01P 3/00; B32B 3/266; B32B 7/12; B32B 27/08; B32B 27/32; B32B 27/36; B65D 65/40; B65D 81/28; B65D 85/34; B32B 2250/02; B32B 2255/10; B32B 2255/26; B32B 2264/104; B32B 2264/303; B32B 2307/31; B32B 2307/518; B32B 2307/7376; B32B 2439/70

(57) ABSTRACT

The invention relates to a preservation and/or anti-fungal device for use with fresh fruit and/or vegetables including tomatoes, grapes and in particular soft fruit, such as but not limited to blueberries, strawberries, raspberries and/or blackberries, wherein the device comprises a packaging container for the fruit or vegetables and a sulphur dioxide (SO₂)-generating multilayer laminated film adapted to seal the container once the fruit or vegetables have been packaged in the container. The invention further relates to a method for preserving fruit or vegetables and/or inhibiting fungal growth with the use of the preservation and/or anti-fungal device.

### FIELD OF THE INVENTION

The invention relates to a preservation and/or anti-fungal device for use with fresh fruit and/or vegetables including tomatoes, grapes and in particular soft fruit, such as but not limited to blueberries, strawberries, raspberries and/or blackberries, wherein the device comprises a packaging container for the fruit or vegetables and a sulphur dioxide (SO₂)-generating multilayer laminated film adapted to seal the container once the fruit or vegetables have been packaged in the container. The invention further relates to a method for preserving fruit or vegetables and/or inhibiting fungal growth with the use of the preservation and/or anti-fungal device.

### BACKGROUND

It is estimated that there may be up to 50% losses in total soft fruit such as in berry sales due to post-harvest damage or decay of berries. This is partly due to the fact that as non-climacteric fruit, berries have to be harvested almost at maturity and will not ripen further once harvested.

At present, the most common methods to maintain quality during the post-harvest period are prompt precooling and storage at low temperatures.

Soft fruit such as berries are typically packaged in wide, shallow containers with no more than three layers of fruit so as to prevent the fruit at the bottom being crushed by the fruit on top. Even more typically, packaging in the form of clamshells or punnets with a lid are used to prevent moisture loss. These also provide mechanical protection to the fragile fruit, can be transparent or clear to allow a consumer to inspect the fruit when purchasing if desired, and are relatively inexpensive. Usually, the containers are vented on the top surface and/or the sides.

However, another method that has been used for packaging of soft fruit is the use of a film-sealable container, either with or without an additional lid, although preferably without the use of an additional lid. This packaging can be a plastic or pulp punnet or tray with a heat or cold-seal film closure and typically is comprised of recyclable material, such as an all-polyethylene terephthalate (PET) pack.

Typically, the infectious agents that cause decay in fresh fruit and vegetables are fungal and/or bacterial. Precooling, preferably immediately after harvest, to around 0° C. is essential to prevent decay development. Generally, a high relative humidity of between about 85-95% is maintained in the transport container or storage rooms, although moisture on the actual fruit or vegetables or in the packaging should be kept to a minimum so as to reduce the levels of fungal rot. Usually transport and storage temperatures are kept below 5° C., often by forced air cooling.

Soft fruit like strawberries, raspberries, blueberries and blackberries in particular also have high respiration rates and are especially susceptible to decay caused by rot-causing pathogens such as Botrytis cinerea, that causes grey mould rot. Presence of ethylene can further stimulate respiration and encourage Botrytis growth.

SO₂-generating devices have mainly been used in blueberries, typically at a concentration of between about 8 to 15% and is generated in the packaging with the use of small packages containing SO₂-generating chemicals such as sodium metabisulphite (SMBS).

However, these SO₂-generating packages have been associated with berry bleaching. Furthermore, the type of packaging used plays an important role in maintaining the freshness and quality of fruit and vegetables, and it has been found that heat-sealed containers such as punnets are more effective than those with lids in terms of reducing weight loss in the produce over time. It would be useful if such a heat-seal film could be adapted to include a preservation and antifungal agent in order to provide protection to fresh produce from farm to consumer, thereby to help to maintain the quality of the fresh produce, extend its shelf life, prevent development of decay and reduce food loss and waste.

Although controlled release SO₂ generating laminate films are known, such as described in Clemes et al. (U.S. Pat. Nos. 5,106,596 and 7,045,182), these have been found to result in significant phytotoxicity when used with soft fruit such as berries due to the sensitive nature of berries compared with grapes which such products are typically designed to be used with. It would be useful to have a product that could also be used for multiple fresh produce applications from vegetables like tomatoes to fruits such as grapes but including problematic fruit such as the soft fruits.

Additionally, due to the requirement of harvesting of berries at near maturation, it would be beneficial if an additional additive such as an ethylene scrubber could be included.

There is therefore still a need for a method or device for preservation of the quality of fruit and vegetables, including tomatoes and grapes, but in particular soft fruit such as berries in a container during shipping or storage and while on the shelf at a retailer, in particular when there is an increase in temperature during shipping, transit or storage which concomitantly results in increased ability for fungal, including Botrytis sp. fungal growth on the fruit or vegetables and their stems.

Furthermore, the multilaminate films current used for preservation of grapes such as those described in Clemes et al. are not recyclable, being produced by a mixture of polymer sheets laminated with a wax layer therebetween. Given the commercial importance of providing materials that can be recycled nowadays, such a device should further be recyclable.

### SUMMARY OF THE INVENTION

According to a first aspect of the invention, there is provided a preservation and/or anti-fungal device for use with fruit and/or vegetables, including tomatoes, grapes and in particular soft fruit such as berries, including but not limited to blueberries, strawberries, raspberries and/or blackberries, wherein the device comprises a packaging container, including a punnet, for containing the fruit and/or vegetables and a sulphur dioxide (SO₂)-generating multilayer laminated film adapted to seal the container through sealable contact of a first, operably inwardly-facing layer of the multilayer laminated film with an open end of the container once the fruit and/or vegetables have been packaged in the container, wherein the SO₂-generating multilayer laminated film comprises:
(i) the first, operably inwardly-facing layer which may be comprised of a material selected from a thermoplastic material; a material coated with a thermoplastic coating such as a heat-seal lacquer including a bonding agent such as an aqueous emulsion containing copolymers, an inorganic crosslinking agent, a solvent-free polyester resin or an aqueous co-polyester dispersion and a filler; or a material selected from a non-thermoplastic polymer or paper without thermoplastic coating;
(ii) a second, operably outwardly-facing layer which may be comprised of a material selected from a thermoplastic material; a material coated with a thermoplastic coating such as a heat-seal lacquer including a bonding agent such as an aqueous emulsion containing copolymers, an inorganic crosslinking agent, a solvent-free polyester resin or an aqueous co-polyester dispersion and a filler; or a material selected from a non-thermoplastic polymer or paper without thermoplastic coating; and
(iii) an inner adhesive layer between the first and second layers, having a coating weight from about 1 GSM to about 100 GSM or any subrange contained therein, comprising an adhesive composition, including a polyurethane adhesive composition, more preferably a solventless polyurethane adhesive composition at a concentration of between about 30% to about 90% weight/weight (w/w) or any subrange contained therein and sodium metabisulphite (SMBS) microgranules having a diameter of between about 1 μm and about 250 μm or any subrange contained therein, at a concentration of between about 10% to about 70% (w/w) or any subrange contained therein,
wherein, where the first, operably inwardly-facing layer comprises a material selected from a non-thermoplastic polymer or paper without thermoplastic coating, the edges of the open end of the container or the edges of the inwardly-facing layer operably in contact with the edges of the open end of the container are coated with an adhesive including but not limited to a cold seal adhesive, pressure sensitive adhesive, peelable adhesive, and the like.

Optionally, the open end of the container may be coated with the adhesive even when the first, operably inwardly-facing layer is a thermoplastic material or a material coated with a thermoplastic coating, although this is not typically necessary.

In particular, the first, operably inwardly-facing layer and/or the second, operably outwardly-facing layer may be comprised of paper including kraft or Machine Glazed Bleached Kraft (MGBK) paper; a polyolefin film including Biaxially Oriented Polypropylene (BOPP), Low Density Polyethylene (LDPE), High Density Polyethylene (HDPE); or a polyester film including Polyethylene Terephthalate (PET). The first and second layers may be of the same or different material.

In a preferred embodiment of the invention, the first, operably inwardly-facing layer and/or the second, operably outwardly-facing layer may be comprised of a polyolefin film layer ranging from about 9 μm to 150 μm or any subrange contained therein; or a paper layer ranging from about 13 GSM to 300 GSM or any subrange contained therein; or a polyester film ranging from about 3 μm to 100 μm or any subrange contained therein. It is to be appreciated that the above-referenced range of dimensions have been discovered by the applicant to be essential for the effective control the water vapour transmission rate (WVTR) and oxygen transmission rate (OTR) in order to generate an effective amount of SO₂ gas for preservation and inhibition of fungal grown in the packaged fruit and/or vegetables by the SO₂-generating multilayer laminated film over the typical time period for transit and storage of the fruit and/or vegetables.

The polyolefin film or polyester film layer of the first operably inwardly-facing layer may either be comprised of a heat sealable material or may have the adhesive coating applied thereto. In the case of a paper layer for the first operably inwardly-facing layer, this may be coated with the adhesive coating to make it sealable to the container of the device.

The container or punnet may be comprised of a substrate including a foil, polymer including PET or BOPP, or paper, pulp or card substrate, including a recycled polymer or paper substrate.

The first, operably inwardly-facing layer and/or the second, operably outwardly-facing layer may optionally be microperforated such as by hot needle perforation, cold needle perforation or laser perforation. The diameter of the perforations, number of perforations and placement of the perforations on the layers may be adapted to control the moisture and the SO₂ gas generation as desired by a user for preservation and inhibition of fungal growth in the packaged fruit and/or vegetables by the SO₂-generating multilayer laminated film over the typical time period for transit and storage, including while on the shelf at a retailer of the fruit and/or vegetables with the diameter of the microperforations ranging from about 0.05 to 2.8 mm or any subrange contained therein. Spacing between the microperforations may optionally be 5 mm horizontally and 10 mm vertically, but it is to be appreciated that the dimensions of the spacing may be adapted as desired by a user.

In an alternative embodiment of the invention, where neither the first, operably inwardly-facing layer nor the second, operably outwardly-facing layer of material is microperforated, the SO₂-generating multilayer laminated film may be microperforated once laminated together, wherein the diameter of the microperforations range from about 0.05 to 2.8 mm or any subrange contained therein. Spacing between the microperforations may optionally be 5 mm horizontally and 10 mm vertically, but it is to be appreciated that the dimensions of the spacing may be adapted as desired by a user.

Further optionally, the SO₂-generating multilayer laminated film may comprise macroperforations, wherein the diameter of the macroperforations range from about 2 mm to 100 mm or any subrange contained therein for control of airflow and moisture levels in the container.

It is to be appreciated that the placement of the micro- and/or macroperforations may be such that selected regions or zones of the SO₂-generating multilayer laminated film contain the micro- and/or macroperforations.

Optionally, either or both of the first, operably inwardly-facing layer and the second, operably outwardly-facing layer may be treated with one or more additional treatments including an anti-fog treatment, a corona treatment, or a chemical treatment for ink adhesion. The first, operably inwardly-facing layer and the second, operably outwardly-facing layer may be comprised of a substantially transparent polymer.

In particular, the solventless polyurethane adhesive composition may have a concentration of between about 40% to about 80% (w/w), or between about 50% to about 70% (w/w) or any subrange contained therein, and the sodium metabisulphite (SMBS) microgranules having a diameter of between about 10 μm and about 70 μm, or between about 20 μm and about 50 μm or any subrange contained therein, have a concentration of between about 40% to about 80% (w/w), or between about 50% to about 70% (w/w) or any subrange contained therein.

The paper may be a paper coated on one or both surfaces with coatings such as, but not limited to any one or more of WVTR or OTR controlling coatings, or hydrophobic, hydrophilic or primer coatings which are well known in the art, or may be an uncoated paper. Alternatively, the paper may be a paper coated on one or both surfaces with a polyolefin film including BOPP, LDPE or HDPE or a polyester film including PET. Where the paper is coated on one surface, the inner adhesive layer is coated onto the coated surface of the paper.

The thickness of the first and second layer paper, polyolefin or polyester films is specifically selected for optimal permeability to allow water vapour to travel from the air in the container inwardly through the paper, polyolefin or polyester films and reach the SMBS microgranules in the inner adhesive layer, thereby activating the SMBS to release SO₂ gas that in turn travels outwardly through the paper, polyolefin or polyester films to reach the fruit or vegetables in the container at a concentration effective to reduce levels of, or inhibit pathogen growth, including Botrytis cinerea (B. cinerea) in the packaged fruit or vegetables.

In particular, a first or second polyolefin film layer may range from 10 μm to 50 μm or from 10 to 30 μm or any subrange contained therein and the thickness of a first or second polyester film layer may range from 10 μm to 50 μm or from 10 to 30 μm or any subrange contained therein.

Furthermore, the concentration and SMBS granule diameters are specifically selected and generate effective levels of SO₂ gas in the container at between about 1 ppm to about 200 ppm, lasting from between 5 to 70 days, more typically from between about 20 to about 30 days.

According to a second aspect of the invention, there is provided a preservation and/or anti-fungal device for use during transport or storage including while on the shelf at a retailer of fruit and/or vegetables including tomatoes, grapes and in particular soft fruit such as berries, including but not limited to blueberries, strawberries, raspberries and/or blackberries, wherein the device comprises a packaging container, including a punnet, for containing the fruit and/or vegetables and a sulphur dioxide (SO₂)-generating multilayer laminated film adapted for flow-wrapping the container with the multilayer laminated film including contact of a first, operably inwardly-facing layer of the multilayer laminated film with an open end of the container once the fruit and/or vegetables have been packaged in the container, wherein the SO₂-generating multilayer laminated film comprises:
(i) a first, operably inwardly-facing layer comprised of a polymer selected from the group comprising a polyolefin film including Biaxially Oriented Polypropylene (BOPP), Low Density Polyethylene (LDPE), High Density Polyethylene (HDPE); or a polyester film including Polyethylene Terephthalate (PET);
(ii) a second, operably outwardly-facing layer comprised of a polymer selected from the group comprising a polyolefin film including Biaxially Oriented Polypropylene (BOPP), Low Density Polyethylene (LDPE), High Density Polyethylene (HDPE); or a polyester film including Polyethylene Terephthalate (PET); and
(iii) an inner adhesive layer between the first and second layers, having a coating weight from about 1 GSM to about 100 GSM or any subrange contained therein, comprising an adhesive composition, including a polyurethane adhesive composition, more preferably a solventless polyurethane adhesive composition at a concentration of between about 30% to about 90% (w/w) or any subrange contained therein and sodium metabisulphide (SMBS) microgranules having a diameter of between about 1 μm and about 250 μm or any subrange contained therein, at a concentration of between about 10% to about 70% (w/w) or any subrange contained therein.

In a preferred embodiment of this second aspect of the invention, the first, operably inwardly-facing layer and/or the second, operably outwardly-facing layer may be comprised of a polyolefin film layer ranging from about 9 μm to 150 μm or any subrange contained therein; or a polyester film ranging from about 3 μm to 100 μm or any subrange contained therein. It is to be appreciated that the above-referenced range of dimensions have been discovered by the applicant to be essential for the effective control the water vapour transmission rate (WVTR) and oxygen transmission rate (OTR) in order to generate an effective amount of SO₂ gas for preservation and inhibition of fungal grown in the packaged fruit and/or vegetables by the SO₂-generating multilayer laminated film over the typical time period for transit and storage and while on the shelf at a retailer of the fruit and/or vegetables.

In particular, the solventless polyurethane adhesive composition may have a concentration of between about 40% to about 80% (w/w), or between about 50% to about 70% (w/w) or any subrange contained therein and the sodium metabisulphite (SMBS) microgranules having a diameter of between about 10 μm and about 70 μm, or between about 20 μm and about 50 μm or any subrange contained therein, have a concentration of between about 40% to about 80% (w/w), or between about 50% to about 70% (w/w) or any subrange contained therein.

The thickness of the first and second layer polyolefin or polyester films is specifically selected for optimal permeability to allow water vapour to travel from the air in the container inwardly through the polyolefin or polyester films and reach the SMBS microgranules in the inner adhesive layer, thereby activating the SMBS to release SO₂ gas that in turn travels outwardly through the polyolefin or polyester films to reach the fruit or vegetables in the container at a concentration effective to reduce levels of, or inhibit pathogen growth, including Botrytis cinerea (B. cinerea) in the packaged fruit or vegetables.

In particular, a first or second polyolefin film layer may range from 10 μm to 50 μm or from 10 to 30 μm or any subrange contained therein and the thickness of a first or second polyester film layer may range from 10 μm to 50 μm or from 10 to 30 μm or any subrange contained therein.

Furthermore, the concentration and SMBS granule diameters are specifically selected and generate effective levels of SO₂ gas in the container at between about 1 ppm to about 200 ppm, lasting from between 5 to 70 days, more typically from between about 20 to about 30 days.

The inner adhesive layer of either aspect of the invention may further optionally comprise a chemical ethylene scrubber selected from the group comprising potassium permanganate, a zeolite, active carbon, pumice and other chemical ethylene scrubbers that are well known in the art.

According to a third aspect of the invention there is provided a method for manufacturing the SO₂-generating multilayer laminated film for use with the preservation and/or anti-fungal device of the invention comprising the steps of:
(a) providing a first, operably inwardly-facing layer which may be comprised of a material selected from a thermoplastic material, a material coated with a thermoplastic coating such as a heat-seal lacquer including a bonding agent such as an aqueous emulsion containing copolymers, an inorganic crosslinking agent, a solvent-free polyester resin or an aqueous co-polyester dispersion and a filler, or a material selected from a non-thermoplastic polymer or paper without thermoplastic coating;
(b) applying an adhesive layer having a coating weight from about 1 GSM to about 100 GSM or any subrange contained therein, comprising an adhesive composition, including a polyurethane adhesive composition, more preferably a solventless polyurethane adhesive composition at a concentration of between about 30% to about 90% (w/w) or any subrange contained therein and sodium metabisulphite (SMBS) microgranules having a diameter of between about 1 μm and about 250 μm or any subrange contained therein, at a concentration of between about 10% to about 70% (w/w) or any subrange contained therein onto the first substrate material layer using a laminating or coating machine;
(c) layering a second, operably outwardly-facing layer which may be comprised of a material selected from a thermoplastic material, a material coated with a thermoplastic coating such as a heat-seal lacquer including a bonding agent such as an aqueous emulsion containing copolymers, an inorganic crosslinking agent, a solvent-free polyester resin or an aqueous co-polyester dispersion and a filler, or a material selected from a non-thermoplastic polymer or paper without thermoplastic coating with the use of a laminating machine onto the adhesive layer such that the adhesive layer is sandwiched in between the first and second layers; and
(d) optionally wherein, where the first, operably inwardly-facing layer comprises a material selected from a non-thermoplastic polymer or paper without thermoplastic coating, performing an additional step of coating the operably inwardly-facing surface of the first layer with a thermoplastic coating such as a heat-seal lacquer including a bonding agent such as an aqueous emulsion containing copolymers, an inorganic crosslinking agent, a solvent-free polyester resin or an aqueous co-polyester dispersion and a filler.

The adhesive layer may optionally further comprise a chemical ethylene scrubber selected from the group comprising potassium permanganate, a zeolite, active carbon, pumice and other chemical ethylene scrubbers that are well known in the art.

In particular, the first, operably inwardly-facing layer and/or the second, operably outwardly-facing layer may be comprised of paper including kraft or MGBK paper; a polyolefin film including BOPP, LDPE, HDPE; or a polyester film including PET. The first and second layers may be of the same or different material.

In particular, the thickness of a first operably inwardly-facing paper layer and/or a second, operably outwardly-facing paper layer may range from about 13 GSM to about 300 GSM or any subrange contained therein, the thickness of a first operably inwardly-facing polyolefin layer and/or a second, operably outwardly-facing polyolefin film layer may range from 9 μm to 150 μm or any subrange contained therein, and the thickness of a first operably inwardly-facing polyester layer and/or a second, operably outwardly-facing polyester film layer may range from 3 μm to 100 μm or any subrange contained therein.

The first, operably inwardly-facing layer and/or the second, operably outwardly-facing layer may optionally be microperforated such as by hot needle perforation, cold needle perforation or laser perforation. The diameter of the perforations, number of perforations and placement of the perforations on the layers are adapted to control the moisture and the SO₂ gas generation for preservation and inhibition of fungal grown in the packaged fruit and/or vegetables by the SO₂-generating multilayer laminated film over the typical time period for transit and storage and while on the shelf at a retailer of the fruit and/or vegetables with the diameter of the microperforations ranging from about 0.05 to 2.8 mm or any subrange contained therein. Spacing between the microperforations may optionally be 5 mm horizontally and 10 mm vertically, but it is to be appreciated that the dimensions of the spacing may be adapted as desired by a user.

In an alternative embodiment of this third aspect of the invention, where neither the first, operably inwardly-facing layer nor the second, operably outwardly-facing layer of material is microperforated, the SO₂-generating multilayer laminated film may be microperforated once laminated together, wherein the diameter of the microperforations range from about 0.05 mm to 2.8 mm or any subrange contained therein. Spacing between the microperforations may optionally be 5 mm horizontally and 10 mm vertically, but it is to be appreciated that the dimensions of the spacing may be adapted as desired by a user.

Further optionally, the SO₂-generating multilayer laminated film may comprise macroperforations, wherein the diameter of the macroperforations range from about 2 mm to 100 mm or any subrange contained therein for control of airflow and moisture levels in the container. Spacing between the macroperforations may optionally be 5 mm horizontally and 10 mm vertically, but it is to be appreciated that the dimensions of the spacing may be adapted as desired by a user.

It is to be appreciated that the placement of the micro- and/or macroperforations may be such that selected regions or zones of the SO₂-generating multilayer laminated film contain either the micro- or macroperforations.

Optionally, either or both of the first, operably inwardly-facing layer and the second, operably outwardly-facing layer may be further treated with one or more additional treatments including an anti-fog treatment, a corona treatment, or a chemical treatment for ink adhesion.

The SO₂-generating multilayer laminated film may be cut to desired dimensions prior to use with the preservation and/or anti-fungal device of the invention.

According to a fourth aspect of the invention there is provided a method of preserving or inhibiting fungal growth in particular B. cinerea in fresh fruit and/or vegetables including tomatoes, grapes and in particular soft fruit, such as but not limited to blueberries, strawberries, raspberries and/or blackberries packaged in a container or punnet during transport and/or storage, including while on the shelf at a retailer, with the use of the preservation and/or anti-fungal device of either aspect of the invention.

According to a fifth aspect of the invention, there is provided a preservation and/or anti-fungal device according to the invention, substantially as herein described with reference to any one of the illustrative examples.

### BRIEF DESCRIPTION OF THE DRAWINGS

The invention shall be described with reference to the following illustrative drawings, which shall not be seen as limiting the scope of the invention:

FIG. 1: shows Botrytis growth inhibition percentage of various PET heat seal sheets in vitro over time (7-days);

FIG. 2: shows Alternaria growth inhibition percentage of various PET heat seal sheets in vitro over time (7-days);

FIG. 3: shows decay development on blueberries over cold storage and shelf-life of 300 g heat seal punnets;

FIG. 4: shows decay development on blueberries over cold storage and shelf-life of 750 g heat seal punnets;

FIG. 5: shows percentage defects recorded on blackberries after 5 days in cold storage at 2° C. and a further 7 days at shelf life at 15° C. in the flow wrap sleeves;

FIG. 6: shows decay development on blueberries during cold storage and shelf-life with the application of heat-seal films;

FIG. 7: shows decay inhibition on blueberries over cold storage and shelf-life with the application of heat-seal films;

FIG. 8: shows decay development on blueberries during cold storage and shelf-life with the application of flow-wrap films;

FIG. 9: shows decay inhibition on blueberries over cold storage and shelf-life with the application of flow-wrap films;

FIG. 10: shows SO₂ damage on blueberries over cold storage and shelf-life with the application of heat-seal films;

FIG. 11: shows SO₂ damage on blueberries over cold storage and shelf-life with the application of flow wrap films;

FIG. 12: shows decay inhibition on tomatoes over cold storage and shelf-life with the application of heat-seal films; and

FIG. 13: shows decay inhibition on tomatoes after cold storage and shelf-life with the application of flow wrap films.

### DETAILED DESCRIPTION

The invention relates to a preservation and/or anti-fungal device for use during transport or storage, including while on the shelf at a retailer of fresh fruit or vegetables including tomatoes, grapes and in particular soft fruit, such as but not limited to blueberries, strawberries, raspberries and/or blackberries, wherein the device comprises a packaging container for the fruit or vegetables and a sulphur dioxide (SO₂)-generating multilayer laminated film adapted to seal the container once the berries have been packaged in the container. The invention further relates to a method of manufacturing the device of the invention and to a method of preserving fruit or vegetables, in particular soft fruit and inhibiting the growth of fungal pathogens including B. cinerea with the device of the invention.

The following description of the invention is provided as an enabling teaching of the invention, is illustrative of the principles of the invention and is not intended to limit the scope of the invention. It will be understood that changes can be made to the embodiment/s depicted and described, while still attaining beneficial results of the present invention. Furthermore, it will be understood that some benefits of the present invention can be attained by selecting some of the features of the present invention without utilising other features. Accordingly, those skilled in the art will recognise that modifications and adaptations to the present invention are possible and can even be desirable in certain circumstances, and are a part of the present invention.

In one illustrative embodiment of the invention, the applicant has developed a preservation and/or anti-fungal device comprising a SO₂-generating multilayer laminated film with a first, operably inwardly-facing layer capable of making sealable contact with the edges of an open end of a punnet once fruit such as berries have been packaged. In a preferred embodiment, the first layer is either made of a heat sealable (thermoplastic) material, or is coated with a thermoplastic coating such as a heat-seal lacquer or similar coating known to those skilled in the art, such that the first layer is heat sealable to various punnet types. There are many such commercial heat-seal coatings available that can be adhered to many types of substrates including films, foil, and paper. One example comprises a bonding agent such as an aqueous emulsion containing copolymers, an inorganic crosslinking agent, a solvent-free polyester resin or an aqueous copolyester dispersion and a filler.

The second, operably outwardly-facing layer of the SO₂-generating multilayer laminated film can optionally be made of a thermoplastic material, be coated with a thermoplastic coating, or merely be a standard substrate material (i.e. not thermoplastic or coated).

### First Layer

The first layer may be any one of the following materials: paper including kraft or Machine Glazed Bleached Kraft (MGBK) paper; a polyolefin film including BOPP, LDPE or HDPE; or a polyester film including PET.

In particular:
the polyolefin film layer may range from 9 μm to 150 μm.
the paper layer may range from 13 GSM to 300 GSM.
the polyester film layer may range from 3 μm to 100 μm.

The polymer films can either be heat sealable or have a coating applied to make it heat seal. The paper needs to have a coating applied to make it sealable the punnets. This makes the substrate materials sealable to all available punnets (such as PET, BOPP or paper punnets).

The thickness and the coating applied to the paper or polymer film layers is selected to control the WVTR and OTR in order to provide an effective amount of SO₂ gas over the required time period for transit and/or storage including while on the shelf at a retailer.

In a particular embodiment of the invention, the paper or polymer film layers are microperforated by means of perforation technology such as (hot needle perforation, cold needle perforation or laser perforation). The diameter of the perforations, number of perforations and placement of the perforations (including the possibility of having perforated and unperforated sections on one film) is selected to control the moisture and the SO₂ gas release through the substrate to the packaged fruit and/or vegetables.

In particular micro perforation diameters can range from 0.05 to 2.8 mm.

### Second Layer

The second paper or polymer film layer may be any one of various substrate materials, such as paper including kraft or Machine Glazed Bleached Kraft (MGBK) paper; a polyolefin film including BOPP, LDPE or HDPE; or a polyester film including PET.

In particular:
the polyolefin film layer may range from 9 μm to 150 μm
the paper layer may range from 13 GSM to 300 GSM
the polyester film layer may range from 3 μm to 100 μm.

As in the first layer, the polymer films can either be heat sealable or have a coating applied to make it heat seal. The paper needs to have a coating applied to make it sealable to the punnets. This is ideal if you want to have a reversable product. It the event that the product does not need to be reversable the materials used do not need to be heat sealable or coated.

The thickness and the coating applied to the paper or polymer film layers is selected to control the WVTR and OTR in order to provide an effective amount of SO₂ gas over the required time period for transit and/or storage including while on the shelf at a retailer.

### Laminate Formulation

The first and second layers are laminated together using an adhesive mixture of a solventless polyurethane and SMBS as the active ingredient. It is also possible to include an ethylene scrubber if desired. Many chemical ethylene scrubbers are known to those skilled in the art and can be incorporated at the suppliers recommended concentration.

The concentration of adhesive can be between about 30% to about 90% weight/weight (w/w) with an SMBS concentration of 10% to about 70% (w/w).

The microgranules of SMBS typically have a diameter of between about 1 μm and about 250 μm.

The coating weight of the adhesive layer that is applied can be between 1 GSM to about 100 GSM.

### Other Methods of Application

Adhesive Sealing of Film onto Punnets

This product uses the same materials and ranges as the SO₂-generating multilayer laminated film above, the main difference being the method of sealing the punnets containing fruit and/or vegetables with the product. Instead of heat sealing the SO₂-generating multilayer laminated film onto the punnets, an adhesive is applied to the punnet or the SO₂-generating multilayer laminated film, and then the film is applied to the punnet thereby forming a seal. The SO₂-generating multilayer laminated film in this case does not need a heat sealable layer, although a heat sealable layer may still be used. The adhesive used can be any food-safe adhesive, including a cold seal adhesive, a pressure sensitive adhesive, a peelable adhesive and the like.

### Example 1

### Heat Seal Product

The following preservation and/or fungal inhibition heat seal devices have been tested in blueberry trials:
1. Perforated first layer heat sealable PET film of between about 5 to about 20 micron thickness laminated to a second layer of between about 5 to about 20 micron thickness unperforated PET film with an adhesive mixture having between 45% to 60% SMBS to 40% to 55% adhesive with a coating weight of between about 15-30 GSM and a SMSB particle size of between about 20 to 50 micron. A perforation hole size of between 1 mm and 5 mm was used—HS 8.1
2. Strip perforated (having a 50 mm unperforated section over the length of the punnet) first layer of between about 5 to about 20 micron thickness heat sealable PET film laminated to a second layer of between about 5 to about 20 micron thickness unperforated PET film with an adhesive mixture having between 45% to 60% SMBS to 40% to 55% adhesive with a coating weight of between about 15-30 GSM and a SMSB particle size of between about 20 to 50 micron. A perforation hole size of between 1 mm and 5 mm was used—HS 8.2
3. First layer of between about 5 to about 20 micron thickness heat sealable PET film laminated to a second layer of between about 5 to about 20 micron thickness unperforated PET film with an adhesive mixture having between 45% to 60% SMBS to 40% to 55% adhesive with a coating weight of between about of 10-20 GSM and a SMSB particle size of between about 20 to 50 micron—HS 7.1
4. First layer between about 5 to about 20 micron thickness heat sealable PET film laminated to a second layer between about 5 to about 20 micron thickness unperforated PET film with an adhesive mixture having between 45% to 60% SMBS to 40% to 55% adhesive with a coating weight of between about of 12-20 GSM and a SMSB particle size of between about 20 to 50 micron—HS 7.2

### Pathology Trials

### Materials and Methods

The heat seal prototypes selected from above were tested for efficacy in vitro by exposing spores and mycelial plugs of Botrytis and Alternaria to the technology. This was done in triplicate for each of the pathogens and treatments over a 7 day period.

### Results

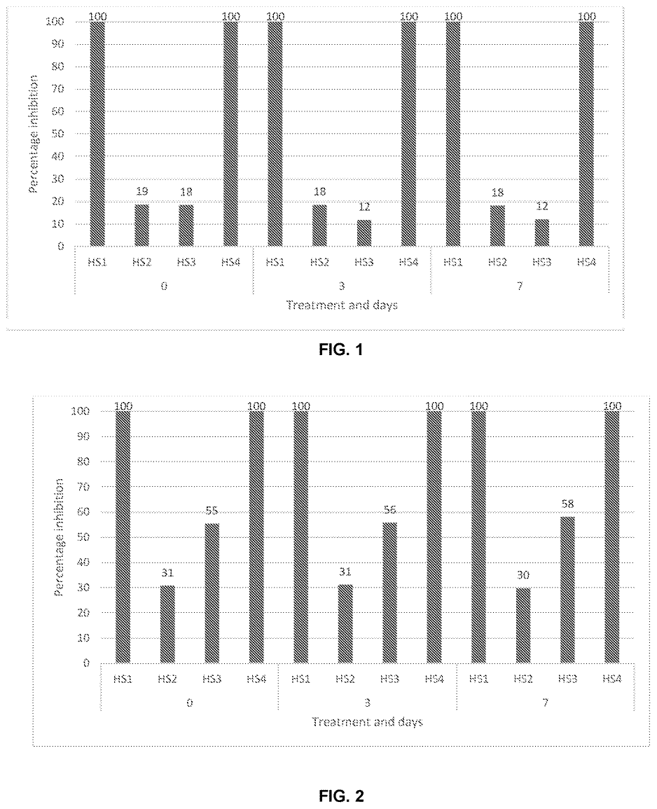

Results are shown in FIGS. 1 and 2.

### Blueberries Trial

### Material and Methods

### Preparation of the Pathogen Inoculum

To obtain the spore suspension from Botrytis cinerea, the fungus was grown on Potato Dextrose Agar (39 g·L⁻¹, PDA, Merck) for 7 days at 20° C. Spores were harvested from the surface of plates by adding 10 mL of sterile distilled water to the culture plates and scraping the surface gently with a sterile hockey stick. The harvested spore suspension was then filtered through a single layer of sterile coffee filter to prepare a stock solution. The spore concentration was counted by using a haemocytometer. The inoculum was prepared on the same day the fruit was inoculated.

### Infection Techniques

Each blueberry fruit was wounded three times using a sterile wound maker, and around 200 blueberries were wounded. The wounded berries were placed in a fruit pulp tray and inoculated with freshly prepared B. cinerea suspensions through spray application. The berries were sprayed until run-off with the spore suspension. These berries were left to airdry in the laminar flow for 45 minutes. To promote spore germination, the pulp trays containing the inoculated berries were placed in a black bag along with a wet paper towel to increase the humidity and stored at 20° C. for 22 hours.

### Plant Material and Storage Conditions

The blueberries were obtained and preserved at 4° C. upon delivery. For each treatment, 12 heat-seal punnets were used. Eight of these heat-seal punnets were filled with two blueberry clamshells to yield a 300 g heat seal punnet, and four were filled with five blueberry clamshells to yield a 750 g heat seal punnet. This were done to monitor the effect the quantity of berries has on the efficacy. Each heat seal punnet was then filled with two inoculated berries, heat-sealed according to the treatments listed in Table 1, and kept cold for three days at 4° C. The treatments and the controls were kept in separate storage rooms. After 3 days of cold storage, two 300 g heat seal punnets and one 750 g heat seal punnet were evaluated for each treatment. The remaining punnets were stored at 10° C. and similar sets as the 3-day cold storage were evaluated after 3, 5 and 7 days to simulate retail storage.

TABLE 1
Treatments used in this trial

| Treatment | Prototype | Description |
|---|---|---|
| 1 | Heat seal 8.1 | Full microperforated |
| 2 | Heat seal 8.2 | Strip microperforated |
| 3 | Heat seal 8.1 + 5 mm | Full microperforated + 6 × 5 mm |
| | ventilated holes | ventilated holes |
| 4 | Heat seal 8.2 + 5 mm | Strip microperforated + 6 × 5 mm |
| | ventilated holes | ventilated holes |
| 5 | NA | Control |

### Results and Discussion

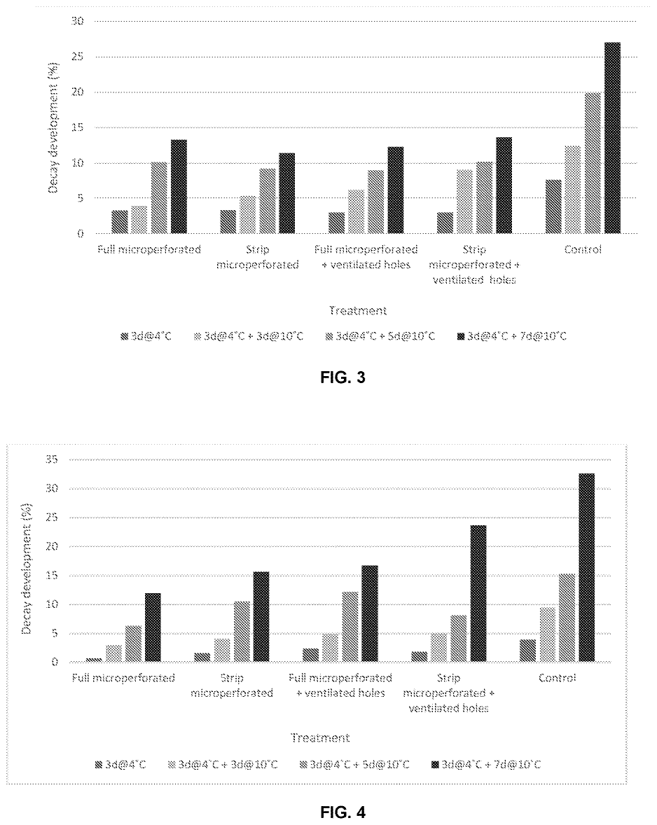

FIGS. 3 and 4 indicate percentage decay development for 300 g and 750 g heat seal punnets respectively. Decay development increased over time. Initially decay percentage was low when evaluation took place after 3-day cold storage however as shelf-life increased, decay development increased. By the end of shelf-life the untreated control had more decay development compared to all treatments. In FIG. 3, all berries treated with the different heat seal films, showed less decay development when compared to the controls. The fully microperforated with/without extra ventilated holes and the strip microperforated without extra ventilated holes treatments was the most effective on the 300 g punnets during storage. In FIG. 4, the least amount of decay was detected in the full microperforated treatment, when punnets were filled up to 750 g the highest amount of decay was observed on the strip microperforated+ventilated holes treatment when compared to the other treatments.

Inhibition efficacy of each treatment was calculated as the weight of decayed berries relative to the weight of the untreated controlled berries. After 3-day cold storage, the highest inhibition percentage was detected in the 750 g punnet that was treated with the full microperforated heat seal film. This treatment also had the highest decay inhibition at the various shelf-life intervals. For the 300 g punnets, the highest decay inhibition after 3-day cold storage was observed on the full microperforated- and strip microperforated+holes treatment. However, during shelf-life the strip microperforated treatment averaged the highest decay inhibition percentage followed by the full microperforated treatment. Percentage decay inhibition is an inverse linear relationship of decay development, therefore results of percentage inhibition corresponds with percentage decay development (Table 2).

TABLE 2
Percentage inhibition of treatments for 300 g and 750
g heat seal punnets at cold storage and shelf-life.

| Cold storage/shelf- | | 300 g | 750 g |
|---|---|---|---|
| life | Treatments | punnets | punnets |
| 3-day cold storage | Full microperforated | 57.02% | 84.20% |
| | Strip microperforated | 56.38% | 59.59% |
| | Full microperforated + | 60.69% | 38.86% |
| | ventilated holes | | |
| | Strip microperforated + | 60.69% | 53.63% |
| | ventilated holes | | |
| 3-day cold storage + | Full microperforated | 68.17% | 69.22% |
| 3-day shelf-life | Strip microperforated | 56.58% | 57.29% |
| | Full microperforated + | 50.44% | 47.60% |
| | ventilated holes | | |
| | Strip microperforated + | 27.56% | 46.43% |
| | ventilated holes | | |
| 3-day cold storage + | Full microperforated | 48.96% | 58.50% |
| 5-day shelf-life | Strip microperforated | 53.67% | 30.90% |
| | Full microperforated + | 54.79% | 20.22% |
| | ventilated holes | | |
| | Strip microperforated + | 48.77% | 46.51% |
| | ventilated holes | | |
| 3-day cold storage + | Full microperforated | 50.90% | 63.45% |
| 7-day shelf-life | Strip microperforated | 57.86% | 52.06% |
| | Full microperforated + | 54.69% | 48.77% |
| | ventilated holes | | |
| | Strip microperforated + | 49.61% | 27.55% |
| | ventilated holes | | |

### Conclusions

The results obtained from the trial indicate that different prototypes evaluated are effective for different grams of berries. The fully microperforated film was the most effective in controlling decay on berries in the 750 g punnets. Whereas the trial results reflects that all berries treated with the different heat seal films, showed less decay development when compared to the controls when stored in the 300 g punnets. Correlations could be drawn between decay development and SO₂ emissions. Treatments that had higher SO₂ emissions had less decay development indicating that the SO₂ released inhibited the growth of Botrytis on berries. Studies have shown that SO₂ restrict protein and enzyme production of pathogens needed for development. SO₂ emissions were higher in the 750 g punnets compared to the emissions detected in the 300 g punnets. This smaller headspace (space between berries and heat seal film) resulted in a lower volume in which SO₂ gas particles were released which resulted in higher concentration of SO₂ gas build.

### Example 2

### Flow Wrap Product

This product uses the same materials and ranges, the main difference is the method of application. This is not sealed onto punnets, instead it is flow-wrapped over the punnets and sealed to itself to fully enclose the punnet containing the berries with the laminated product.

The trial with the flow wrap devices set out below was performed using blackberries.
1. 10 to 20 micron BOPP first layer laminated to a 10 to 20 micron BOPP second layer with an adhesive mixture therebetween having between 45% to 60% SMBS to 40% to 55% adhesive with a coating weight of between about 10-20 GSM and a SMSB particle size of between about 20 to 50 micron—FSL 7
2. 15 to 25 micron BOPP first layer laminated to a 15 to 25 micron BOPP second layer, with an adhesive mixture therebetween having between 45% to 60% SMBS to 40% to 55% adhesive with a coating weight of between about 10-20 GSM and a SMSB particle size of between about 20 to 50 micron—FSL 8
3. 20 to 40 micron BOPP first layer laminated to a 20 to 40 micron BOPP second layer, with an adhesive mixture therebetween having between 45% to 60% SMBS to 40% to 55% adhesive with a coating weight of between about 10-20 GSM and a SMSB particle size of between about 20 to 50 micron—FSL 9

### Flow Wrap Pathology Trials

### Material and Methods

In this particular example, punnets containing 125 g of blackberries were manually flow wrapped by cutting the SO₂ films tested to size and wrapping these around the punnet. The film was then sealed around the punnets using a heat seal machine. Blackberry punnets were initially kept in cold storage at 2° C. for up to 5 days, thereafter the flow wrap treatments were applied, and the flow wrapped punnets was stored for a further 7 days at shelf life temperature of 15° C. It is to be noted however, that flow wrapping can be applied directly after harvest and that this is likely the preferred method.

### Results

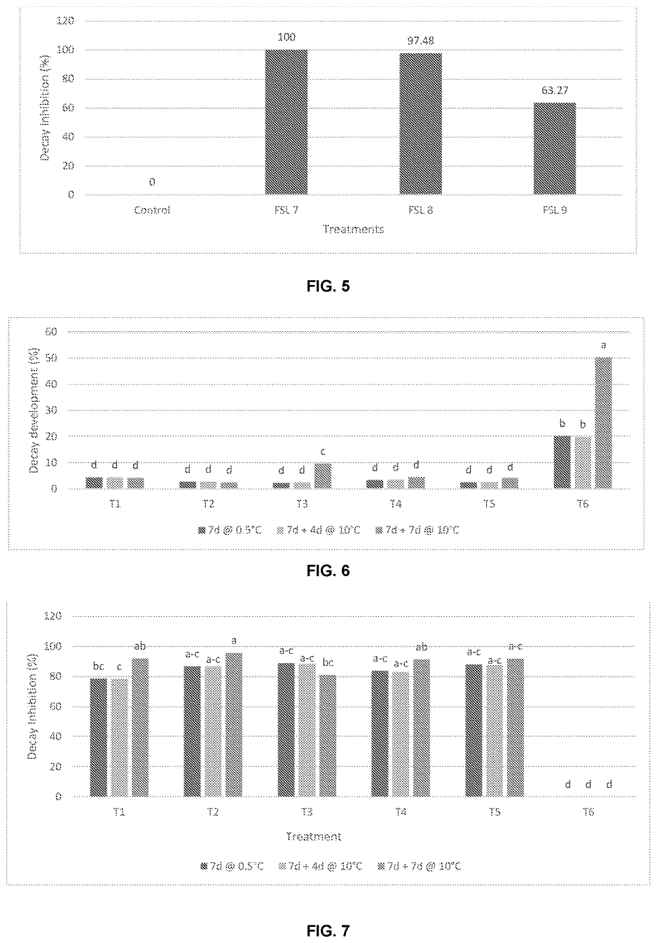

The results are shown in FIG. 5.

### Example 3

Investigating the efficacy of PET heat seal and flow
wrap prototypes against Botrytis on blueberries

| | |
|---|---|
| Trial duration | 14 days |
| Heat-seal | 8.1 Full perforated |
| products | 7.1 Thin coating |
| tested | |
| Flow wrap | FSL 12 |
| products | FSL 13 |
| tested | FSL 12 - 2 perforated |
| | FSL 12 - 4 perforated |
| Location | Cape Town, South Africa |
| Objective | To evaluate the efficacy of PET heat seal and flow wrap |
| | prototypes against Botrytis decay development on |
| | blueberries during cold storage and retail shelf-life |
| Conclusion | To conclude, both heat-seal prototypes tested have the |
| | potential to reduce postharvest losses of blueberries |
| | without affecting the blueberry appearance or other |
| | quality parameters. Whereas, although effective, |
| | perforation holes should be included for flow wrap |
| | prototypes, due to the higher concentration of gas |
| | release to prevent SO₂ damage. |

### 1. Introduction

Blueberry fruit crops are primarily marketed fresh around the world, with cold storage being the most effective method for limiting losses in the short term. A significant increase in global blueberry demand has put the blueberry industry under intense pressure to find a way to extend the crop's storage life, which could result in market opportunities and increased exports. Blueberries are perishable and easily spoilt, and fruit rots caused by fungal pathogens are a major factor limiting blueberry storage and shelf life. Sulphur dioxide (SO₂) gas is commonly used on table grapes to prevent decay during storage, either through initial fumigation of fruit from the field followed by weekly fumigation of storage rooms or through the presence of in-package pads containing sodium metabisulfite. These SO₂ sheets are made up of a series of laminated plastic membranes that are bonded together by either a wax or a solventless adhesive layer containing precise SMBS concentrations and particle size. Moisture in the fruit package is absorbed by the sheets and reacts with the sulphite to produce SO₂.

Recently, the use of SO₂ gas has been investigated as a potential postharvest solution for decay on blueberries. However, in order to realize the full potential of this technology, several factors must be considered, as the kinetics of SO₂ release sheets can be influenced. These factors include the fruit's quality, adequate exposure time and concentration, the time elapsed between harvest and gasification, the temperature and relative humidity (RH) in the packaging and storage rooms, the fruit varieties, packaging material, the amount of berries and free space within the carton, and the handling of the cold chain during storage. The selection of the type and method of SO₂ generation must be carefully made, as high concentrations of the gas can affect the physiochemical and sensory characteristics of the fruit, as well as being harmful to humans and the environment in high doses.

Given the above, the experiment aimed to evaluate the efficacy of different heat seal and flow wrap films to reduce Botrytis decay on blueberries without affecting other quality parameters.

### 2. Objective

To evaluate the efficacy of PET heat seal and flow wrap prototypes against Botrytis decay development on blueberries during cold storage and retail shelf-life.

### 3. Material and Methods

### 3.1.1. Preparation of the Pathogen Inoculum

To obtain the spore suspension from Botrytis cinerea, the fungus was grown on Potato Dextrose Agar (39 g·L⁻¹, PDA, Merck) for 7 days at 20° C. Spores were harvested from the surface of plates by adding 10 mL of sterile distilled water to the culture plates and scraping the surface gently with a sterile hockey stick. The harvested spore suspension was filtered through a single layer of sterile coffee filter. The spore concentration was counted by using a haemocytometer. The inoculum was prepared on the same day infection took place.

### 3.1.2. Infection Techniques

Each fruit was wounded with a sterile wound maker. 20 ul of a freshly prepared B. cinerea suspensions were placed into each wound. These berries were left to airdry in the laminar flow for 45 minutes.

### 3.1.3. Trial Packing and Storage Conditions

Quality blueberries were obtained from Six 33 blueberry growers. For each treatment (Tables 3 and 4), nine heat seal punnets per treatment were used. A single Botrytis inoculated berry was added to each heat-seal punnet containing blueberries. A pre-cut heat-seal film for each treatment was placed on top of the respective punnets. For the flow wrap treatments, the punnets were enclosed and sealed. The berries were moved to a cold room @ 0.5° C. After 7 days at @ 0.5° C., all punnets were removed. After which, 1 punnet of each treatment was removed for evaluations. The rest were moved to 10° C., still with heat-seal films and flow wrap. For the 4 and 7 days shelf-life study (10° C.), the same procedure were followed.

TABLE 3
Heat-seal treatment list

| Treatment | Prototype |
|---|---|
| 1 | 7-layer SO₂ sheet - “Vivo 1” |
| 2 | 5-layer SO₂ sheet - “Tomasys” |
| 3 | 3-layer SO₂ sheet - “Fast Fresh” |
| 4 | Heat Seal 8.1 Full perforated |
| 5 | Heat Seal 7.1 Thin coating |
| 6 | Control |

TABLE 4
Flow wrap treatment list

| Treatment | Prototype |
|---|---|
| 1 | 7-layer SO₂ sheet - “Vivo 1” |
| 2 | 5-layer SO₂ sheet - “Tomasys” |
| 3 | 3-layer SO₂ sheet - “Fast Fresh” |
| 4 | FSL 12 |
| 5 | FSL 13 |
| 6 | FSL 12 - 2 perforated |
| 7 | FSL 12 - 4 perforated |
| 8 | Control |

### 4. Quality Measurements

### 4.1.1 Postharvest Decay

Decayed berries were weighed and expressed as percentage per sample. Pathogens were not identified in this experiment and the focus was primarily on the percentage unmarketable berries due to postharvest decay in general.

### 4.1.2. Sulphur Dioxide/SO₂ Emissions

Damaged berries were counted and expressed as percentage per sample. SO₂ emissions were measured at each of the evaluation period.

### 5. Results and Discussion

### 5.1.1. Postharvest Decay

### Heat-Seal

All products were highly effective against Botrytis. There were no significant differences between all treatments except for Fast Fresh after 7 days shelf-life, which showed significantly more decay development (FIG. 6). Both heat seal 8.1 (full perforated) and 7.1 (thin coating) showed over 80% effectiveness after all storage periods (FIG. 7).

From 4 to 7 days shelf-life the Botrytis development increased significantly for the controls compared to the SO₂ treatments. This could be attributed to the SO₂ gas released at required dosages over time by the films which disinfect berry surfaces by killing and eliminating any actively growing pathogenic spores during the cold and shelf-life storage. SO₂ gas reacts with water content of products and forms sulphurous acid at low pH. Sulphurous acid (H₂SO₂) reacts with the cell membrane and blocks enzymes of the microorganism by reducing essential disulphide (—S—S—) linkages.

### Flow Wrap

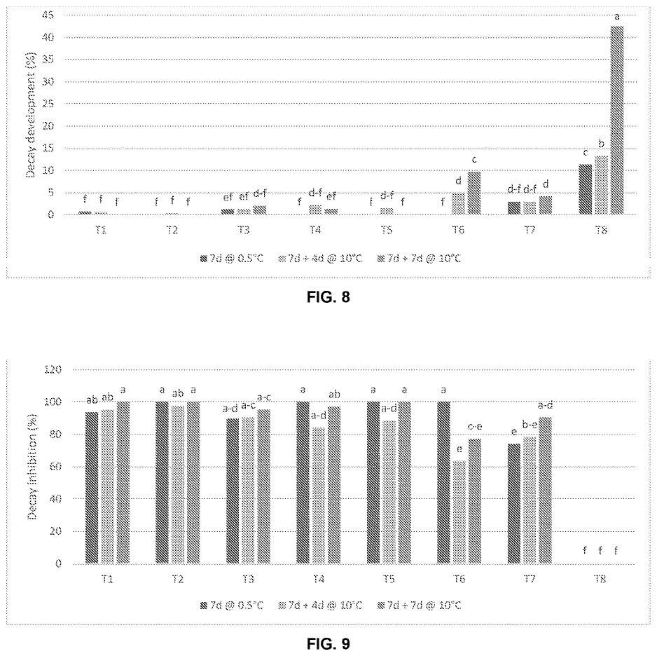

All treatments were highly effective against Botrytis development after cold storage and shelf-life. FSL 13 was the most effective of the prototypes tested (FIG. 8 and FIG. 9).

### 5.1.2. Sulphur Dioxide/SO₂ Emissions

### Heat-Seal

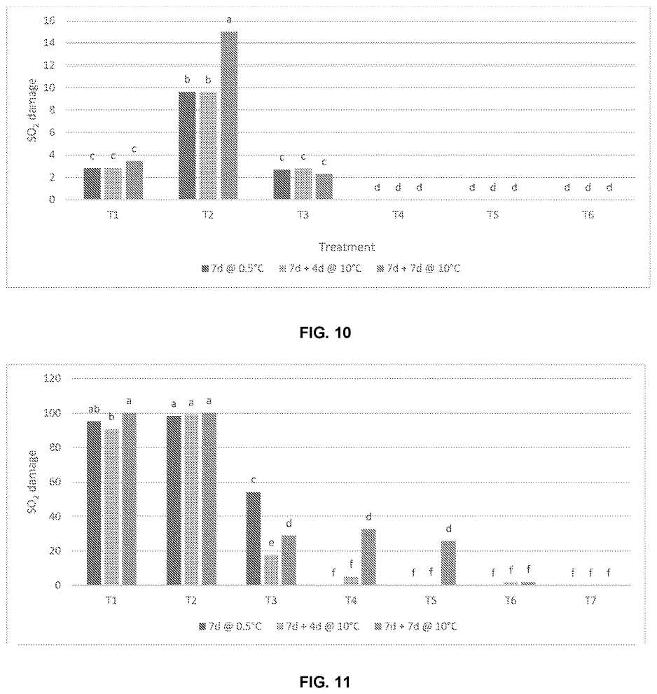

Results reflects that berries treated with Heat Seal 8.1 Full perforated and Heat Seal 7.1 Thin coating showed no SO₂ damage over all storage periods. The 5-layer SO₂ sheet—Tomasys heat seal film caused the highest percentage of damage followed by 7-layer SO₂ sheet—Vivo 1 and 3-layer SO₂ sheet—Fast Fresh (FIG. 10).

### Flow Wrap

Results reflects that the berries treated with FSL 12 developed SO₂ damage only during shelf-life storage, increasing as shelf-life storage days increased. FSL 13 only developed SO₂ damage after 7 days. Very low to no SO₂ damage was recorded after 4- and 7-days shelf-life storage for FSL 12 when perforated. Berries treated with the rest of the treatments included were unmarketable due to the high percentage of SO₂ damage (FIG. 11).

### 6. Conclusions

The results obtained from the trial indicate that different heat-seal prototypes evaluated are effective against the development of Botrytis on berries. Both heat seal 8.1 (full perforated) and 7.1 (thin coating) showed over 80% effectiveness after all storage periods. From 4 to 7 days shelf-life the Botrytis development increased significantly for the controls compared to the SO₂ treatments.

Berries treated with flow wrap films, reflected that all treatments were highly effective after cold storage and shelf-life against Botrytis development. However, FSL 13 was the most effective of the prototypes tested in the trial against Botrytis decay. Although still effective, FSL 12 showed a reduction in efficacy when perforation holes were included.

To conclude, both heat-seal prototypes tested have the potential to reduce postharvest losses of blueberries without affecting the blueberry appearance or other quality parameters. Whereas, although effective, perforation holes should be included for flow wrap prototypes, due to the higher concentration of gas release to prevent SO₂ damage.

### Example 4

Investigating the efficacy of PET heat seal and flow
wrap prototypes against Botrytis on tomatoes

| | |
|---|---|
| Trial duration | 14 days |
| Heat-seal | 8.1 Full perforated |
| products | 7.1 Thin coating |
| tested | |
| Flow wrap | FSL 12 |
| products | FSL 13 |
| tested | FSL 12 - 2 perforated |
| | FSL 12 - 4 perforated |
| Location | Cape Town, South Africa |
| Objective | To evaluate the efficacy of PET heat seal and flow wrap |
| | prototypes against Botrytis decay development on |
| | tomatoes during cold storage and retail shelf-life. |
| Conclusion | To conclude, the trial reflects that 7.1 (thin coating) Heat |
| | seal and FSL 12 + 2 holes flow wrap can be suitable |
| | products to reduce postharvest losses of tomatoes without |
| | affecting other quality parameters. |

### 1. Introduction

During storage and transportation, fruits and vegetables act as a suitable substrate for fungal pathogens that cause rot, making fruits unfit for market use, therefore causing huge postharvest economical losses. Botrytis is regarded as the most important postharvest fungal pathogen that causes significant losses in fresh fruits, vegetables, and ornamentals. It can attack a wide range of crops using various modes of infection. The fungus can also develop under conditions during storage, shipment and marketing making control of the disease a challenge. Harvested crops are particularly vulnerable to Botrytis infection because unlike vegetative tissue, harvested commodities are senescing rather than developing. Another major postharvest disease that causes significant losses is Alternaria fruit rot. This disease is caused by the filamentous fungus Alternaria alternata. A. alternata infects when the fruit develops injury or becomes debilitated during prolonged storage. The control of A. alternata consist of the use of fungicides, however, negative impacts of fungicidal residues in edible fruits and vegetables on human health cannot be overruled and alternative control products need to be investigated.

The use of SO₂ generating sheets have been widely investigated as an alternative use to fungicides due to the low health risk and affordability of SO₂ sheets. In response to a call from industry to have “active packaging” that can reduce waste on prepacked fresh fruit and vegetables, the applicant attempted to develop heat-seal and flow wrap films coated with SMBS to provide protection to fresh produce from farm to consumer. These are aimed to help to maintain quality of fruit, extend shelf-life, prevent development of decay, and reduce food loss and waste. The proposed technology differs from the currently used commercial technology in the form of an SO₂ pad, as it relates to an SMBS coated heat-seal film or flow wrap film for use with punnets. Unlike existing heat-seal and flow wrap films, the new SMBS-coated product will be biodegradable or 100% recyclable. Because the technology is new and will be used on fresh tomatoes, it's crucial to understand the release profile of the prototypes. Different types of sheets have been developed by the applicant in which the rate of SO₂ is controlled. There are two different release phases, quick and/or slow, and the sheets are available in many different sizes. PET heat sealable and flow wrap films are preferable, in that these are recyclable, as are the punnets with which these can be used. Therefore heat sealable and flow wrap PET films containing SO₂ were investigated for efficacy against Botrytis.

### 2. Objective

To evaluate the efficacy of PET heat seal and flow wrap prototypes against Botrytis decay development on tomatoes during cold storage and retail shelf-life.

### 3. Material and Methods

### 3.1.1. Preparation of the Pathogen Inoculum

To obtain the spore suspension from Botrytis cinerea, the fungus was grown on Potato Dextrose Agar (39 g·L⁻¹, PDA, Merck) for 7 days at 20° C. Spores were harvested from the surface of plates by adding 10 mL of sterile distilled water to the culture plates and scraping the surface gently with a sterile hockey stick. The harvested spore suspension was filtered through a single layer of sterile coffee filter. The spore concentration was counted by using a haemocytometer. The inoculum was prepared on the same day infection took place.

### 3.1.2. Infection Techniques

Each tomato was wounded with a sterile wound maker. 20 ul of a freshly prepared B. cinerea suspensions were placed into each wound. These tomatoes were left to airdry in the laminar flow for 45 minutes.

### 3.1.3. Trial Packing and Storage Conditions

For each treatment (Table 5 and 6), nine heat seal punnets per treatment were used. Three Botrytis inoculated tomatoes were added to each heat-seal and flow wrap punnet. A pre-cut heat-seal film of each treatment were place on top of the punnets. For the flow wrap treatments, the punnets were enclosed with the films and sealed. The tomato punnets were moved to a cold room @ 10° C. After 7 days at @ 10° C., all punnets were removed. 1 punnet of each treatment was removed for evaluations. The rest was moved to 18° C. still with heat-seal films and flow wrap. For the 4 and 7 days shelf-life study (18° C.), the same procedure was followed.

TABLE 5
Heat-seal treatment list

| Treatment | Prototype |
|---|---|
| 1 | 7-layer SO₂ sheet - “Vivo 1” |
| 2 | 5-layer SO₂ sheet - “Tomasys” |
| 3 | 3-layer SO₂ sheet - “Fast Fresh” |
| 4 | Heat Seal 8.1 “Full perforated” |
| 5 | Heat Seal 7.1 “Thin coating' |
| 6 | Control |

TABLE 6
Flow wrap treatment list

| Treatment | Prototype |
|---|---|
| 1 | 7-layer SO₂ sheet - “Vivo 1” |
| 2 | 5-layer SO₂ sheet - “Tomasys” |
| 3 | 3-layer SO₂ sheet - “Fast Fresh” |
| 4 | FSL 12 |
| 5 | FSL 13 |
| 6 | FSL 12 - 2 perforated |
| 7 | FSL 12 - 4 perforated |
| 8 | Control |

### 4. Quality Measurements

### 4.1.1 Postharvest Decay

To determine the percentage inhibition, the lesion diameter from the inoculated area was measured with a digital calliper.

### 4.1.2. Sulphur Dioxide/SO₂ Emissions

Damaged berries were expressed as Yes/No.

### 5. Results and Discussion

### 5.1.1. Postharvest Decay

### Heat-Seal

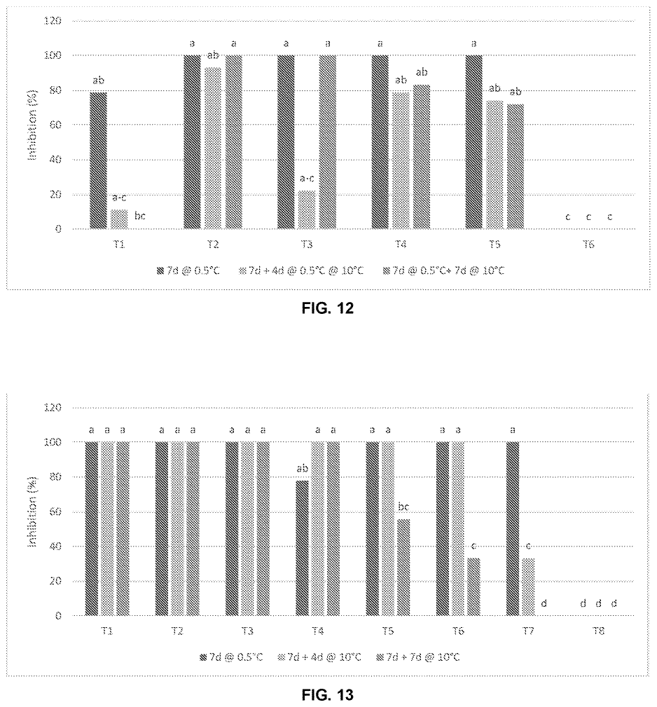

All five SO₂ products were highly effective against Botrytis development. In terms of the specific heat seal prototypes, there were no significant differences between the two prototypes during all storage periods. Efficacy decreased as storage periods increased, however both heat-seal 8.1 (full perforated) and 7.1 (thin coating) still showed over 70% effectiveness after all storage periods (FIG. 12).

### Flow Wrap

For the flow wrap treatments, similar results reflected. The prototypes included were highly effective against Botrytis development after cold storage and 4 days shelf-life. However, as shelf-life storage increased to 7 days, the efficacy of the specifically formulated flow wrap prototypes (T4-T7) decreased significantly. This trend was more noticeable when perforations was added to FSL 12. This prototype with 4 perforation holes was the least effective of all the treatments. FSL 13 was the most effective prototype during all storage periods (FIG. 13).

### 5.1.2. Sulphur Dioxide/SO₂ Emissions

### Heat-Seal

Results reflects that the tomatoes treated with Heat Seal 8.1 Full perforated showed slight signs of SO₂ damage (Table 7). Heat Seal 7.1 Thin coating showed no SO₂ damage over all storage periods. However, the 7-layer SO₂ sheet—Vivo 1, 3-layer SO₂ sheet—Fast Fresh and 5-layer SO₂ sheet—Tomasys, resulted in unmarketable fruit due to the severe SO₂ damage caused.

### Flow Wrap

Due to the higher emissions released from flow wrap treatments, results reflect more severe SO₂ damage, especially for the 7-layer SO₂ sheet—Vivo 1, 3-layer SO₂ sheet—Fast Fresh and 5-layer SO₂ sheet—Tomasys treatments. Tomatoes treated with FSL 12, FSL 12+2 holes and FSL 13 developed slight SO₂ damage during all storage periods. FSL 12 when perforated with 4 holes resulted in no SO₂ damage.

TABLE 7
SO₂ damage for tomatoes treated with heat-seal films.

| Treatment | SO₂ damage |
|---|---|
| 7-layer SO2 sheet - Vivo 1 | Yes |
| 5-layer SO₂ sheet - Tomasys | Yes |
| 3-layer SO₂ sheet - Fast Fresh | Yes |
| Heat Seal 8.1 Full perforated | Yes |
| Heat Seal 7.1 Thin coating | No |
| Control | No |

### 6. Conclusion

The results obtained from the trial indicate that different heat-seal prototypes evaluated are effective against the development of Botrytis on tomatoes. Both heat seal 8.1 (full perforated) and 7.1 (thin coating) showed over 70% effectiveness after all storage periods. As shelf-life storage increased to 7 days, the efficacy decreased but not significantly. Tomatoes treated with flow wrap films, reflected that FSL 12 and 13 were highly effective. However, FSL 12, with increase in perforation, decreased in efficacy as shelf-life storage extends.

The trial reflects that SO₂ damage can be most successfully limited with low perforated flow wrap bags.

To conclude, the trial reflects that 7.1 (thin coating) Heat seal and FSL 12+2 holes flow wrap can be suitable products to reduce postharvest losses of tomatoes without affecting other quality parameters.

1. A preservation and/or anti-fungal device for use with fresh fruit and/or vegetables, comprising tomatoes, grapes, soft fruit, berries including blueberries, strawberries, raspberries and blackberries, wherein the device comprises a packaging container, including a punnet, for containing the fruit and/or vegetables and a sulphur dioxide (SO₂)-generating multilayer laminated film adapted to seal the packaging container through sealable contact of a first, operably inwardly-facing layer of the multilayer laminated film with an open end of the packaging container once the fruit and/or vegetables have been packaged in the packaging container, wherein the SO₂-generating multilayer laminated film comprises:
(i) a first, operably inwardly-facing layer and a second, operably outwardly-facing layer which are each comprised of a material selected from:
A. a thermoplastic material,
B. a material coated with a thermoplastic coating including a heat-seal lacquer selected from a bonding agent including an aqueous emulsion containing copolymers, an inorganic crosslinking agent, a solvent-free polyester resin or an aqueous co-polyester dispersion and a filler, or
C. a non-thermoplastic polymer or a paper without thermoplastic coating; and
(ii) an inner adhesive layer between the first and second layers, having a coating weight from about 1 GSM to about 100 GSM, or any subrange contained therein, comprising an adhesive composition, including a polyurethane adhesive composition, comprising a solventless polyurethane adhesive composition at a concentration of between about 30% to about 90% weight/weight (w/w) or any subrange contained therein, and sodium metabisulphite (SMBS) microgranules having a diameter of between about 1 μm and about 250 μm or any subrange contained therein at a concentration of between about 10% to about 70% (w/w) or any subrange contained therein, and optionally a chemical ethylene scrubber selected from the group comprising potassium permanganate, a zeolite, active carbon or pumice,
wherein, where the first, operably inwardly-facing layer comprises a material selected from a non-thermoplastic polymer or paper without thermoplastic coating, the edges of the open end of the packaging container or the edges of the inwardly-facing layer operably in contact with the edges of the open end of the packaging container are coated with an adhesive including a cold seal adhesive, pressure sensitive adhesive, or peelable adhesive; and
wherein the first, operably inwardly-facing layer is microperforated and the diameter of the microperforations range from about 0.05 to about 2.8 mm or any subrange contained therein.

2. The preservation and/or anti-fungal device according to claim 1, wherein the first, operably inwardly-facing layer and/or the second, operably outwardly-facing layer is selected from the group comprising paper, including kraft or Machine Glazed Bleached Kraft (MGBK) paper; a polyolefin film including Biaxially Oriented Polypropylene (BOPP), Low Density Polyethylene (LDPE), High Density Polyethylene (HDPE); or a polyester film including Polyethylene Terephthalate (PET) and wherein the first and second layers are of the same or different material.

3. The preservation and/or anti-fungal device according to claim 1, wherein the first, operably inwardly-facing layer and/or the second, operably outwardly-facing layer are comprised of:
(i) a polyolefin film layer ranging from about 9 μm to 150 μm or any subrange contained therein; or
(ii) a paper layer ranging from about 13 GSM to 300 GSM or any subrange contained therein; or
(iii) a polyester film ranging from about 3 μm to 100 μm or any subrange contained therein.

4. The preservation and/or anti-fungal device according to claim 2, wherein the polyolefin film or polyester film layer of the first operably inwardly-facing layer is comprised of the heat sealable material or has the heat-seal lacquer applied thereto.

5. The preservation and/or anti-fungal device according to claim 3, wherein the paper layer of the first operably inwardly-facing layer is coated with a heat seal lacquer or adhesive to make it sealable to the packaging container.

6. The preservation and/or anti-fungal device according to claim 1, wherein the packaging container is comprised of a substrate, including a recycled substrate, selected from the group comprising a foil, a polymer including PET or BOPP, or a paper, pulp or card.

7. The preservation and/or anti-fungal device according to claim 1, wherein the first, operably inwardly-facing layer and/or the second, operably outwardly-facing layer are microperforated and the diameter of the microperforations range from about 0.05 to 2.8 mm or any subrange contained therein.

8. The preservation and/or anti-fungal device according to claim 1, wherein the first, operably inwardly-facing layer and/or the second, operably outwardly-facing layer are macroperforated and the diameter of the macroperforations range from about 2 to 100 mm or any subrange contained therein.

9. The preservation and/or anti-fungal device according to claim 7, wherein the SO₂-generating multilayer laminated film comprises selected regions or zones having microperforations.

10. The preservation and/or anti-fungal device according to claim 1, wherein either or both of the first, operably inwardly-facing layer and the second, operably outwardly-facing layer is treated with one or more additional treatments selected from the group comprising an anti-fog treatment, a corona treatment, or a chemical treatment for ink adhesion.

11. The preservation and/or anti-fungal device according to claim 1, wherein the first, operably inwardly-facing layer and the second, operably outwardly-facing layer are comprised of a substantially transparent polymer.

12. The preservation and/or anti-fungal device according to claim 1, wherein the solventless polyurethane adhesive composition has a concentration of between about 40% to about 80% (w/w), or between about 50% to about 70% (w/w) and the sodium metabisulphite (SMBS) microgranules have a diameter of between about 10 μm and about 70 μm, or between about 20 μm and about 50 μm and a concentration of between about 40% to about 80% (w/w), or between about 50% to about 70% (w/w).

13. The preservation and/or anti-fungal device according to claim 1, wherein the paper is coated on one or both surfaces with any one or more of WVTR or OTR controlling coatings, or hydrophobic, hydrophilic or primer coatings, or wherein the paper is uncoated.

14. The preservation and/or anti-fungal device according to claim 1, wherein the paper is coated on one or both surfaces with a polyolefin film including BOPP, LDPE or HDPE or a polyester film including PET, such that where the paper is coated on one surface, the inner adhesive layer is coated onto the coated surface of the paper.

15. The preservation and/or anti-fungal device according to claim 14, wherein the first or second polyolefin film layer thickness ranges from 10 μm to 50 μm or from 10 to 30 μm and the thickness of the first or second polyester film layer ranges from 10 μm to 50 μm or from 10 to 30 μm.

16. A preservation and/or anti-fungal device for use during transport or storage of fresh fruit and/or vegetables comprising tomatoes, grapes, soft fruit, berries including blueberries, strawberries, raspberries and blackberries, wherein the device comprises a packaging container, including a punnet, for containing the fruit and/or vegetables and a sulphur dioxide (SO₂)-generating multilayer laminated film adapted for flow-wrapping the packaging container with the multilayer laminated film such that a first, operably inwardly-facing layer of the multilayer laminated film is in contact with an open end of the container once the fruit and/or vegetables have been packaged in the container, and wherein the SO₂-generating multilayer laminated film comprises:
(i) the first, operably inwardly-facing layer and a second operably outwardly-facing layer, each comprised of a polymer selected from the group comprising a polyolefin film including Biaxially Oriented Polypropylene (BOPP), Low Density Polyethylene (LDPE), High Density Polyethylene (HDPE); or a polyester film including Polyethylene Terephthalate (PET); and
(ii) an inner adhesive layer between the first and second layers, having a coating weight from about 1 GSM to about 100 GSM, or any subrange contained therein, comprising an adhesive composition, including a polyurethane adhesive composition further including a solventless polyurethane adhesive composition at a concentration of between about 30% to about 90% weight/weight (w/w) or any subrange contained therein and sodium metabisulphide (SMBS) microgranules having a diameter of between about 1 μm and about 250 μm or any subrange contained therein, at a concentration of between about 10% to about 70% (w/w) or any subrange contained therein, and optionally a chemical ethylene scrubber selected from the group comprising potassium permanganate, a zeolite, active carbon or pumice;
wherein the first, operably inwardly-facing layer and/or the second, operably outwardly-facing layer are perforated and the diameter of the perforations range from about 0.05 to about 2.8 mm or any subrange contained therein; or from about 2.0 mm to about 100 mm, or any subrange contained therein; or a combination of perforations of from about 0.05 to about 2.8 mm or any subrange contained therein, or from about 2.0 mm to about 100 mm or any subrange contained therein.

17. The preservation and/or anti-fungal device according to claim 16, wherein the first, operably inwardly-facing layer and/or the second, operably outwardly-facing layer is comprised of a polyolefin film layer ranging from about 9 μm to 150 μm or any subrange contained therein; or a polyester film ranging from about 3 μm to 100 μm or any subrange contained therein.

18. The preservation and/or anti-fungal device according to claim 15, wherein the solventless polyurethane adhesive composition has a concentration of between about 40% to about 80% (w/w), or between about 50% to about 70% (w/w) or any subrange contained therein, and the sodium metabisulphite (SMBS) microgranules have a diameter of between about 10 μm and about 70 μm, or between about 20 μm and about 50 μm, or any subrange contained therein and have a concentration of between about 40% to about 80% (w/w), or between about 50% to about 70% (w/w) or any subrange contained therein.

19. The preservation and/or anti-fungal device according to claim 16, wherein the thickness of the first or second polyolefin film layer ranges from 10 μm to 50 μm or from 10 to 30 μm or any subrange therein, and the thickness of the first or second polyester film layer ranges from 10 μm to 50 μm or from 10 to 30 μm or any subrange therein.

20. A method for manufacturing a SO₂-generating multilayer laminated film for use with the preservation and/or anti-fungal device of the invention comprising the steps of:
(i) providing a first, operably inwardly-facing layer comprised of:
A. a thermoplastic material,
B. a material coated with a thermoplastic coating including a heat-seal lacquer selected from a bonding agent including an aqueous emulsion containing copolymers, an inorganic crosslinking agent, a solvent-free polyester resin or an aqueous co-polyester dispersion and a filler, or
C. a non-thermoplastic polymer or a paper without thermoplastic coating; and
(ii) applying an adhesive layer having a coating weight from about 1 GSM to about 100 GSM, or any subrange contained therein, comprising an adhesive composition, including a polyurethane adhesive composition, comprising a solventless polyurethane adhesive composition at a concentration of between about 30% to about 90% weight/weight (w/w) or any subrange contained therein, and sodium metabisulphite (SMBS) microgranules having a diameter of between about 1 μm and about 250 μm or any subrange contained therein at a concentration of between about 10% to about 70% (w/w) or any subrange contained therein onto the first substrate material layer using a laminating or coating machine;
(iii) layering a second, operably outwardly-facing layer which comprised of:
A. a thermoplastic material,
B. a material coated with a thermoplastic coating including a heat-seal lacquer selected from a bonding agent including an aqueous emulsion containing copolymers, an inorganic crosslinking agent, a solvent-free polyester resin or an aqueous co-polyester dispersion and a filler, or
C. a non-thermoplastic polymer or a paper without thermoplastic coating with the use of a laminating machine onto the adhesive layer such that the adhesive layer is sandwiched in between the first and second layers; and
(iv) wherein the first, operably inwardly-facing layer and/or the second, operably outwardly-facing layer are perforated and the diameter of the perforations range from about 0.05 to about 2.8 mm or any subrange contained therein; or from about 2.0 mm to about 100 mm or any subrange contained therein; or a combination of perforations of from about 0.05 to about 2.8 mm or any subrange contained therein, or from about 2.0 mm to about 100 mm or any subrange contained therein including by hot needle perforation, cold needle perforation or laser perforation either before or after lamination of the layers to form the SO₂-generating multilayer laminated film.

21. The method according to claim 20, wherein where the first, operably inwardly-facing layer comprises a material selected from a non-thermoplastic polymer or paper without thermoplastic coating, the method further comprises performing an additional step of coating the operably inwardly-facing surface of the first layer with a thermoplastic coating including a heat-seal lacquer selected from a bonding agent including an aqueous emulsion containing copolymers, an inorganic crosslinking agent, a solvent-free polyester resin or an aqueous co-polyester dispersion and a filler.

22. The method according to claim 20, wherein the adhesive layer further comprises a chemical ethylene scrubber selected from the group comprising potassium permanganate, a zeolite, active carbon, or pumice.

23. The method according to claim 20, wherein the first, operably inwardly-facing layer and/or the second, operably outwardly-facing layer is comprised of paper including kraft or MGBK paper; a polyolefin film including BOPP, LDPE, HDPE; or a polyester film including PET and wherein the first and second layers are comprised of the same or different material.

24. The method according to claim 23, wherein the thickness of the first operably inwardly-facing paper layer and/or the second, operably outwardly-facing paper layer ranges from about 13 GSM to about 300 GSM or any subrange contained therein; the thickness of the first operably inwardly-facing polyolefin layer and/or the second, operably outwardly-facing polyolefin film layer ranges from 9 μm to 150 μm or any subrange contained therein; and the thickness of the first operably inwardly-facing polyester layer and/or the second, operably outwardly-facing polyester film layer ranges from 3 μm to 100 μm or any subrange contained therein.

25. The method according to claim 20, further including a step wherein the first, operably inwardly-facing layer and/or the second, operably outwardly-facing layer are microperforated including by hot needle perforation, cold needle perforation or laser perforation either before or after lamination of the layers to form the SO₂-generating multilayer laminated film.

26. The method according to claim 25, wherein the microperforation diameters range from about 0.05 to 2.8 mm or any subrange contained therein.

27. The method according to claim 20, wherein the first, operably inwardly-facing layer and/or the second, operably outwardly-facing layer are macroperforated including by hot needle perforation, cold needle perforation or laser perforation either before or after lamination of the layers to form the SO₂-generating multilayer laminated film.

28. The method according to claim 27, wherein the macroperforation diameters range from about 2.0 to 100 mm or any subrange contained therein.

29. The method according to claim 20, including a step wherein the first, operably inwardly-facing layer and/or the second, operably outwardly-facing layer are both micro- and macroperforated and the micro- and/or macroperforations are placed in regions or zones of the SO₂-generating multilayer laminated film as desired by a user.

30. The method according to claim 20, wherein the method further comprises one or more steps of treatment including an anti-fog treatment, a corona treatment, or a chemical treatment for ink adhesion.

31. A method of preserving or inhibiting fungal growth in fresh fruit and/or vegetables, comprising tomatoes, grapes, soft fruit, berries including blueberries, strawberries, raspberries and blackberries, packaged in a container or punnet during transport and/or storage with the use of the preservation and/or anti-fungal device according to any one of claim 1.

32. (canceled)

33. The preservation and/or anti-fungal device according to claim 8, wherein the SO₂-generating multilayer laminated film comprises selected regions or zones having macroperforations.
